(19) United States
(12) Patent Application Publication
(10) Pub. No.: US 2025/0242490 A1
(43) Pub. Date: Jul. 31, 2025

(54) SYSTEM FOR GRASPING/SUCTIONING UNKNOWN OBJECTS

(71) Applicants: TRUONG VAN NGUYEN, HA NOI (VN); DUNG TIEN HOANG, HA NOI (VN); LAM THANH BUI, HA NOI (VN); TRUNG QUANG LE, HA NOI (VN)

(72) Inventors: TRUONG VAN NGUYEN, HA NOI (VN); DUNG TIEN HOANG, HA NOI (VN); LAM THANH BUI, HA NOI (VN); TRUNG QUANG LE, HA NOI (VN)

(73) Assignee: HANOI UNIVERSITY OF INDUSTRY, HA NOI (VN)

(21) Appl. No.: 19/080,809

(22) Filed: Mar. 15, 2025

(30) Foreign Application Priority Data
May 29, 2024 (VN) 1-2024-03897
Feb. 17, 2025 (VN) 1-2025-01007

(51) Int. Cl. B25J 9/16; B25J 15/06; B25J 15/08

(52) U.S. Cl. CPC B25J 9/1612; B25J 9/1697; B25J 15/0616; B25J 15/08

(57) ABSTRACT

The present invention relates to a system for grasping/suctioning unknown objects, using a robot arm or an industrial robot. The system comprising a 3D camera for taking images of the objects contained in said containing space and creating a 3D panoramic image; an unknown object segmentation model unit for receiving said 3D panoramic image as an input, and a processing the 3D panoramic image for creating a 2D mask and a 3D point cloud of each individual object/product in the 3D panoramic image; an unknown object grasping/suctioning model unit for outputting grasping/suctioning poses related to the target object based on the 3D point cloud of the target object, and selecting one of the feasible grasping/suctioning poses for controlling the robot arm to grasp/suction the target object according to said feasible grasping/suctioning pose.

### TECHNICAL FIELD

The present invention relates to a system for grasping/suctioning objects, in particularly, a system for grasping/suctioning unknown objects in a product cart.

### BACKGROUND

As already known, in the field of objects grasping/suctioning, integrating functions of grasping/suctioning on an industrial robot is quite common. Factors of speed and success rate when grasping/suctioning objects is very important and may be considered as the deciding factor of methods for grasping/suctioning objects. Inputting is a very necessary factor for grasping/suctioning objects, there may be based on 2D input (2D image), 2,5D (depth map), and 3D. Using input as 2D or 2,5D would not available on some models requiring complex manual features and lacking of analytical geometry can lead to side effects. Grasping/suctioning objects having a plurality of approaches, but there are two main approaches which are: depending on models or not depending on models. In the approach of depending on models it is based on a grasping database which is a pre-built model of labeled 3D models with feasible grasping sets and quality metrics provided by support tools. As for that, data collecting is a very difficult and computational loads for the system are huge.

A system for generating gripping poses of objects using a 3D image as an input is disclosed in the patent publication No. U.S. Pat. No. 11,878,433B2. In this document, inventors have mentioned a method for detecting a grasping position of a robot when gripping a target object, comprising: collecting target RGB images and target depths of a target object by different views; inputting each target RGB image to a target object segmentation network for calculating and obtaining a pixel RGB pixel region of the target object in the target RGB image, and inputting a depth pixel region to an optimal classifying position generating network to generate an optimal grasping position for gripping the target object; inputting the depth pixel region of the target object and the optimal grasping position to a grasping position quality evaluating network for calculating score of the optimal grasping position, and selecting an optimal grasping position with the highest score to be the final optimal grasping position of the robot.

Features of the above system are to use a 3D image as an input information, therefore it has enough information of the image that supports for a better processing. According to the image processing algorithm in the patent publication No. U.S. Pat. No. 11,878,433B2, the target RGB images and the target depth images of the target object are in different views, this makes the time is increased for processing and calculating. In this document there is no reference that the target object being placed with many other objects or in a messy state, therefore a collision checking is not mentioned.

Another system for generating grasping poses of objects also uses a 3D image as an input, is disclosed in the patent publication No. U.S. Pat. No. 9,987,744B2. In this document, inventors have provided a method for generating object grasping poses by an end effector of a robot. An image that captures at least a portion of the object is provided to a user via a user interface output device of a computing device. The user may select one or more pixels in the image via a user interface input device of the computing device. The selected pixels are utilized to select one or more specific 3D points that correspond to a surface of the object in the robot's environment. A grasp pose is determined based on the specific 3D points. For example, a local plane may be fit based on the specific 3D points and a grasp pose determined based on a normal of the local plane. Control commands can be provided to cause the grasping end effector to be adjusted to the grasp pose, after which a grasp is attempted.

Image processing algorithms in the patent publication No. U.S. Pat. No. 9,987,744B2 would capture at least a portion of the object. Similarly to the patent publication No. U.S. Pat. No. 11,878,433B2 above, in the document No. U.S. Pat. No. 9,987,744B2 only mentions about generating grasp poses for an object which is placed individually but not an object being placed in a messy state and a collision checking. In this document, there is no assessment criteria for grasping poses of an object, for example, whether it is possible or convenient for the movement of the robot's joints.

Yet another approach for generating object grasping poses is disclosed in the patent publication No. U.S. Pat. No. 11,701,771B2. In this document, the system determines a set of possible grasp poses that allow a robot to successfully grasp an object by generating a set of potential grasp poses, and then evaluating the performance of each potential grasp pose. The system performs a refinement operation on the grasp poses, and based on an evaluation of the poses, creates an improved set of possible grasps for the object. Features of image processing algorithms in this document would generating a set of grasping poses for an object and assessing them. This leads to a hug calculation loads of the system because there are grasping poses with unsuccessful results needed to be eliminated and an output will be a set of grasping poses after assessment. This also results in a huge capacity. Similarly to U.S. Pat. No. 9,987,744B2 and U.S. Pat. No. 9,987,744B2, this document also not mention that the object being placed in a messy state and a collision checking during actual grasping.

To overcome issues in which objects being placed in a messy state, complex and collision checking during actual grasping, an approach is provided in the patent publication No. U.S. Pat. No. 10,646,999B2. This approach relates to a system to solves problem of grasp pose detection and finding suitable graspable affordance for picking objects from a confined and cluttered space, such as the bins of a rack in a retail warehouse by creating multiple surface segments within bounding box obtained from a neural network based on object recognition module. Surface patches are created using a region growing technique in depth space based on surface normal directions. A Gaussian Mixture Model based on color and depth curvature is used to segment surfaces belonging to target object from background, thereby overcoming inaccuracy of object recognition module trained on a smaller dataset resulting in larger bounding boxes for target objects. Target object shape is identified by using empirical rules on surface attributes thereby detecting graspable affordances and poses thus avoiding collision with neighboring objects and grasping objects more successfully. However, these architectures may be complex, require specialized knowledge, difficulty in calibration, and speed may be an issue to consider.

Hence, there is a need for a solution of the system for grasping/suctioning unknown objects, may improve accuracy, speed and reliability for predicting optimal grasping/suctioning poses, may be simplified during network design and training, and may address one or more practical aspects not yet covered.

### SUMMARY

An object of the present invention is to provide a system for grasping/suctioning unknown objects, may overcome one or more of the above-mentioned problems.

Another object of the present invention is to provide a system for grasping/suctioning unknown objects, may improve accuracy, speed and reliability for predicting optimal grasping/suctioning poses.

Yet another object of the present invention is to provide a system for grasping/suctioning unknown objects, may be simplified during network design and training.

Yet another object of the present invention is to provide a system for grasping/suctioning unknown objects, capable to perform grasping/suctioning operations for objects with various different shapes and surfaces.

Various objects to be achieved by the present invention are not limited to the aforementioned objects, and those skilled in the art to which the disclosure pertains may clearly understand other objects from the following descriptions.

To achieve one or more above objects, the present invention provides a system for grasping/suctioning unknown objects comprising:
at least one robot arm including at least one gripping unit and one or more suctioning units adeptly provided for grasping/suctioning a target object among objects contained in a containing space;
at least one 3D camera for taking images of the objects contained in said containing space and creating a 3D panoramic image;
an unknown object segmentation model unit for receiving said 3D panoramic image as an input, and processing the 3D panoramic image for creating a 2D mask and a 3D point cloud of each individual object in the 3D panoramic image;
an unknown object grasping/suctioning model unit for outputting grasping/suctioning poses related to the target object attached to at least one portion of visible points of the 3D point cloud of the target object respectively, and selecting a feasible grasping/suctioning pose for controlling the robot arm to grasp/suction the target object according to said feasible grasping/suctioning pose;
wherein:
the target object is one object among the objects contained in the containing space is selected based on its visible score, wherein a visible score of any object among the objects contained in the containing space is calculated by a ratio between a visible score of the 3D point cloud of the object and a total score of the 3D point cloud of the object;
the feasible grasping/suctioning pose is a grasping/suctioning pose among the grasping/suctioning poses related to the target object is selected based on a collision calculation, wherein said collision is a collision between the robot arm and the objects contained in the containing space in the vicinity of the target object, and/or objects which make a limitation to the containing space or present in the containing space.

Optionally, the target object is gripped by at least one gripping unit independently, suctioned by one or more suctioning units independently, or simultaneously gripped by at least one gripping unit and suctioned by one or more suctioning units.

Preferably, the robot arm including at least one suctioning unit is defined as a center suctioning unit, the gripping unit including grippers, and the center suctioning unit is in the center of the grippers of the gripping unit, such that when the gripping unit performs for gripping the target object, the grippers of the gripping unit contact gripping points on a surface of the target object, the suctioning unit is in the center of said grippers is capable of contacting a suctioning point on the surface of the target object which is in the center of said gripping points.

According to an embodiment, the robot arm having an arm terminal segment, is defined as the farthest arm segment from a fixed structure that supports the robot arm, for mounting the gripping unit and the suctioning units thereon, suctioning units other than the center suctioning unit, are defined as the surrounding suctioning units,
wherein:
the gripping unit including a grasping hand with at least two gripping fingers, the center suctioning unit is in the center of said at least two gripping fingers,
each of the surrounding suctioning units including a stroke cylinder and a suction cup is mounted at one end of the stroke cylinder, such that the suction cup capable of pushing out and retracting,
wherein the stroke cylinders are fixed surrounding the arm terminal segment, and there have axes of the stroke cylinders parallel to each other and parallel to an axis of the arm terminal segment.

Optionally, the number of the surrounding suctioning units are two, three, or more than three.

According to an embodiment, when defining an imaginary circle which is a circle perpendicular to the axis of the arm terminal segment and with its center is on the axis of the arm terminal segment, then the surrounding suctioning units are located within the range of substantially a half of said imaginary circle.

Preferably, the system further comprising an object classification model unit for classifying objects contained in the containing space, based on at least surfaces and shapes of the objects, and based on classification result of an object to determine manners to obtain said object out of the containing space, wherein the manner to obtain the object is defined as gripping, or suctioning, or gripping and suctioning at the same time using the robot arm.

Preferably, said system is configured to:
determining normal vectors at the visible points of said 3D point cloud corresponding to the surface of the target object,
calculating angles between the normal vectors with the vertical axis of the coordinate according to the 2D image,
removing points with calculated angles greater than 45°, and
outputting grasping/suctioning poses related to the target object attached to at least one portion of visible points of the 3D point cloud which are not removed.

Preferably, the grasping/suctioning poses related to the target object are simultaneously calculated by appropriate matrix operations

According to an embodiment, the unknown object segmentation model unit is trained based on a training data set including real data and fake data, wherein the real data are created by 3D camera through actual photography processes and/or taken from available datasets, and the fake data are generated from the real data with a close realism by adding random factors to real images.

Preferably, the unknown object segmentation model is a combined model using a YOLOv5 network model for detecting objects and a CNN network model having a branch with a mask head for detecting not only bounding boxes but also masks of the objects.

According to an embodiment, the containing space is a product cart, and the objects contained in the containing space are products contained in said product cart.

Preferably, the system further comprising conveyor belts, products contained in product carts being grasping/suctioning out by the robot arm shall be placed on the conveyor belts ready for transferring.

Preferably, the system further comprising a cabin using partition panels for forming a workspace area with at least the robot arm, the conveyor belts, and the product carts in said workspace area.

Said system further comprising a computer is placed outside of said cabin, for monitoring and performing control tasks for system operations.

The 3D panoramic images taken during operation of the system are processed and added to a training data set as additional real data.

### BRIEF DESCRIPTION OF THE DRAWINGS

FIG. 1 is a flowchart illustrating an operating process of the system for grasping/suctioning unknown objects according to an implementing embodiment of the present invention;

FIG. 2 is a flowchart illustrating an image processing of the system for grasping/suctioning unknown objects according to an implementing embodiment of the present invention;

FIG. 3 is a flowchart illustrating a process to generate a fake dataset according to an implementing embodiment of the present invention;

FIG. 4 is a flowchart illustrating steps used in the optimized PointNetGPD algorithm according to an implementing embodiment of the present invention;

FIG. 5 is a screenshot illustrating point clouds at the surface of detected objects according to an implementing embodiment of the present invention;

FIG. 6 is a screenshot illustrating segmentations of separated objects according to an implementing embodiment of the present invention;

FIG. 7 is a screenshot illustrating normal vectors generated after using the optimized PointNetGPD according to an implementing embodiment of the present invention;

FIG. 8 is a perspective view illustrating the system for grasping/suctioning unknown objects according to an implementing embodiment of the present invention;

FIG. 9 is a perspective view illustrating grasping/suctioning hand assembly;

FIG. 10 is a perspective view illustrating grasping poses of the robot arm with the portion A is enlarged;

FIG. 11 is a perspective view illustrating a suctioning pose of the robot arm with the portion B is enlarged;

FIG. 12 is a perspective view illustrating more clearly a specific suctioning pose of the robot arm being perform to suction an object which is a product contained in the product cart with the portion C is enlarged;

FIG. 13 is a perspective view illustrating the product cart according to an exemplary embodiment of the present invention;

FIG. 14 is a perspective view illustrating grasping/suctioning hand assembly including gripping unit and the plurality of suctioning units according to an exemplary embodiment of the present invention;

FIG. 15 is a perspective view illustrating a grasping pose combined with a suctioning pose of the robot arm with the portion D is enlarged;

FIG. 16 is a perspective view illustrating a suctioning pose combined more than one suctioning unit of the robot arm with the portion E is enlarged;

FIG. 17 is a perspective view illustrating a suctioning pose using a surrounding suction cup with the portion F is enlarged;

FIG. 18 is a perspective view illustrating a suctioning pose using another surrounding suction cup other than the surrounding suction cup used in FIG. 17; and

FIG. 19 is a perspective view illustrating a suctioning pose using yet another surrounding suction cup other than the surrounding suction cups used in FIG. 17 and FIG. 18.

### DESCRIPTION OF EMBODIMENTS

Hereinafter, advantages, efficiencies, and inventive concepts of the present invention shall be understood more clearly through the detailed description of the preferred embodiments with reference to the accompanying drawings. In the drawings, same reference numbers are intended to indicate same or equivalent components or elements and commonly used in the whole description, therefore in several drawings or several parts of a drawings may not show one or more reference numbers for a purpose that makes the drawings becoming simplified and facilitating for showing composed components or different inventive concepts of the present invention, in this scenario, relationships between certain components or elements with corresponding reference numbers may be clearly illustrated when referring to other drawings or other components on the drawing. In addition, the components and elements illustrated in the drawings is not complied actual sizes and shapes, several components or elements shall be exaggerated and may be presented by simplified blocks for illustrated purposes and facilitating for descriptive purpose. It should be understood that the embodiments described herein is only exemplary for fully understanding of the inventive steps and advantages of the present invention, without any limitation of the present invention to the embodiments.

In general, a system for grasping/suctioning objects, or more in particularly, a system for grasping/suctioning unknown objects is intended to provide object grasping/suctioning poses, be simplified during network design and training, such that reducing computational costs, enhancing processing speed for each grasping/suctioning operation.

According to a preferred embodiment, a system for grasping/suctioning objects according to the present invention substantially comprising: a robot arm; a 3D camera; an unknown object segmentation model unit; an unknown object grasping/suctioning model unit.

The robot arm includes at least one gripping unit and one or more suctioning units adeptly provided for grasping/suctioning a target object among objects contained in a containing space.

The 3D camera is for taking images of the objects contained in said containing space and creating a 3D panoramic image.

The unknown object segmentation model unit is for receiving said 3D panoramic image as an input, and processing the 3D panoramic image for creating a 2D mask and a 3D point cloud of each individual object in the 3D panoramic image.

The unknown object grasping/suctioning model unit is for outputting grasping/suctioning poses related to the target object based on the 3D point cloud of the target object, and selecting a feasible grasping/suctioning pose for controlling the robot arm to grasp/suction the target object according to said feasible grasping/suctioning pose.

According to the preferred embodiment, the target object is one object among the objects contained in the containing space is selected based on its visible score, wherein a visible score of any object among the objects contained in the containing space is calculated by a ratio between a visible score of the 3D point cloud of said object and a total score of the 3D point cloud of the object.

The feasible grasping/suctioning pose is a grasping/suctioning pose among the grasping/suctioning poses related to the target object is selected based on a collision calculation, wherein said collision is a collision between the robot arm and the objects contained in the containing space in the vicinity of the target object, and/or objects which make a limitation to the containing space or present in the containing space.

According to one or more embodiments, the target object is selected as an object with the highest visible score, but not be limited thereto.

Many different methods or manners may be used to select which object is the target object, for example the target object may be selected as an object with a visible score greater or equal to a predetermined visible score; and combined with one or more other selecting conditions, including but not limited to, shape, surface roughness/smoothness, size, positions relative to the robot arm, for example.

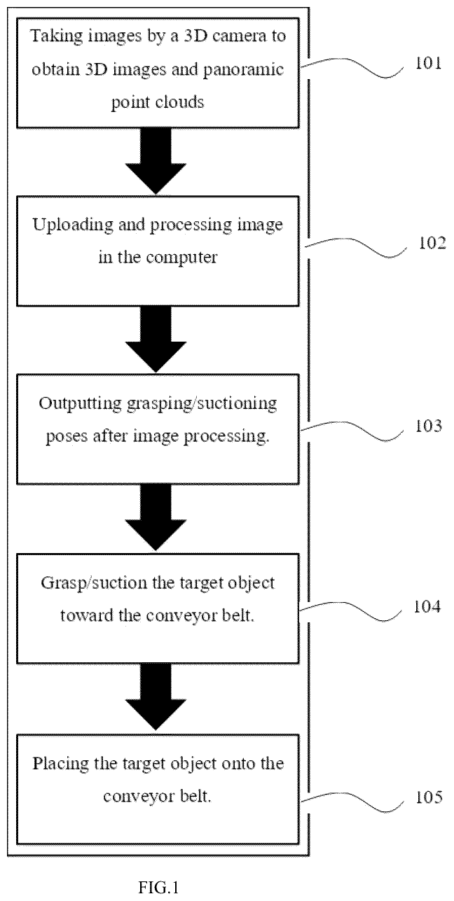

According to one or more embodiments, the system for grasping/suctioning unknown objects according to the present invention may use a computer. A flowchart for implementing the system for grasping/suctioning unknown objects according to the embodiments is shown in FIG. 1.

As shown in FIG. 1, the implementing starts from the step 101, taking images by the 3D camera to obtain 2D images and panoramic point clouds (e.g. 3D point clouds); next at the step 102, uploading and processing images in the computer; next at the step 103, outputting grasping/suctioning poses after said image processing; and the at the step 104, grasping/suctioning objects toward a conveyor belt; finally at the step105, placing the objects on the conveyor belt.

According to one or more implementing embodiments, the system according to the present invention may use the unknown object segmentation model unit for receiving said 3D panoramic image as an input, and processing the 3D panoramic image for creating a 2D mask and a 3D point cloud of each individual object in the 3D panoramic image; and the unknown object grasping/suctioning model unit for outputting grasping/suctioning poses related to the target object attached to at least one portion of visible points of the 3D point cloud of the target object respectively, and selecting the feasible grasping/suctioning pose for controlling robot arm to grasp/suction the target object according to said feasible grasping/suctioning pose. The unknown object segmentation model unit and the unknown object grasping/suctioning model unit may be implemented by a software program installed in the computer, but not be limited thereto.

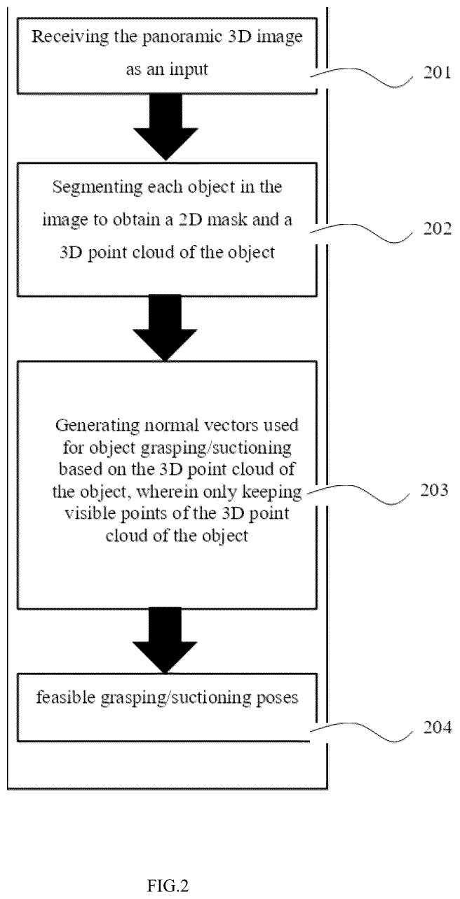

A flowchart in FIG. 2 is an example of the system for grasping/suctioning unknown objects, illustrating more clearly an image processing in the computer.

In FIG. 2 is a flowchart for illustrating more clearly a method in which an image taken by the 3D camera is uploaded to the computer for the image processing. At the step 201, receiving the 3D panoramic image as an input; next at the step 202 segmenting each object in the image to obtain 2D masks and 3D point clouds of the objects by the computer. Said segmenting for the objects in the image may be implemented through a unknown object segmentation model that is pre-trained and pre-stored in the computer; next, at the step 203, generating normal vectors used for grasping/suctioning objects based on the 3D point cloud of the objects, wherein only keeping visible points of the 3D point cloud of the object; and the at the step 204, generating grasping/suctioning poses by the computer.

In general, the grasping/suctioning poses may be generated by the computer in any appropriate method or algorithm, such as methods or algorithms that have been disclosed in the patent documents mentioned in the above background section of the present invention. In addition, articles with title “PointNetGPD: Detecting Grasp Configurations from Point Sets” of Xiaojian Ma et al., “SuctionNet-1Billion: A Large-Scale Benchmark for Suction Grasping” of Hanwen Cao et al., together with relevant citations, may also be useful. The entire contents of these documents are intended to give hereby as a reference and should be incorporated to the present invention in any possible way.

As an example, the grasping may be implemented by: firstly, determining the surface of the object to be grasped/gripped, then generating possible grasping poses and finally checking collisions; and the suctioning may be implemented by: determining a center of gravity of the object to be suctioned, then determining a surface corresponding to the point cloud, and finally checking collisions.

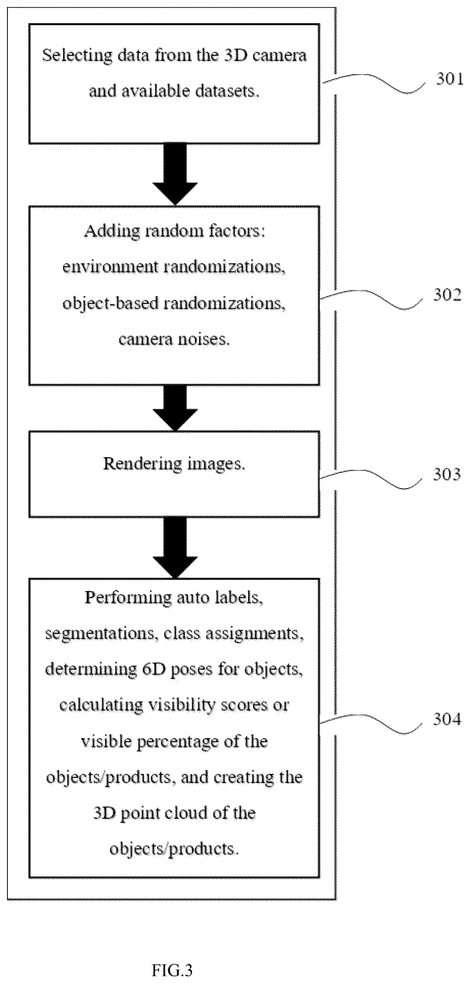

Obviously, the computer may be any computer such as a station computer, a desktop computer, a laptop, etc. In addition, the present invention may use appropriate devices or computational systems to replace for the computer, such as a site or remote server, a site or remote server system, a computational hardware module or a set of computational hardware modules, etc. But not be limited thereto. In FIG. 3 illustrates an exemplary flowchart for creating a training data set used for segmentation training each object in an image to obtain masks and the point cloud of the object/products, used to train the unknown object grasping/suctioning model unit for outputting feasible/suitable grasping/suctioning poses.

As shown in FIG. 3, the implementing starts from the step 301, collecting data from the 3D camera and available datasets; next at the step 302, adding random factors: environment randomizations, object-based randomizations, camera noises; next at the step 303, rendering images; and finally at the step 304, performing auto labels, segmentations, class assignments, determining 6D poses for objects, calculating visibility scores or visible percentage of the objects/products, and creating the 3D point cloud of the objects/products. Such that, generating a training data set including real data, and fake data with a close realism as real images.

According to an exemplary embodiment, the real data will be taken from the 3D camera and taken from some popular available datasets such as: ABC Dataset, Ommi Dataset, etc.

In addition, the fake dataset will be generated by taking a huge number of certain objects from the real dataset. Then, it is applied with randomization factors.

As for randomization factors: environment randomizations, object-based randomization, and noises of the 3D camera.

Firstly, changing environment randomizations will use a HDR heaven library to create various environments from indoor to outdoor. In addition, brightness level will be also changed randomly. This makes a same image frame may have different light intensities.

Secondly, changing object-based factors and properties according to the embodiment will change materials and structures. As for materials, when it changes randomly a material then factors about roughness, shine, rust, scratches, etc., of the object will be also changed. As for structures, for the same object may assign with different packaging, pictures.

Thirdly, applying digital noises for the camera. This is considered as a novel and relatively useful improvement. Based on realistic camera simulation, that is: a practical camera always has noises called as sensor noises. Therefore, will apply RGB noises to created images. After applying all the randomization factors above, proceeding to render images.

A preprocessor unit may be applied for creating 2D images, frames of the point cloud and other different characteristics is to create a complete dataset.

It is easy to recognize that, as for quality of obtained dataset closely Similarly to real images taken from the camera, enough coverage, details and parameters to be included in training without additional real data (in several cases). As for the number of images generated are unlimited. The creating time is faster, and less resource consumptions.

In the embodiment, performing auto labels to objects, comprising: labeling and segmenting objects, assigning class for the objects, 6D poses for the objects, percentage visibility scores and 3D point clouds for the objects. Wherein, as for the percentage visibility score of the objects and the 3D point cloud are two novel improvements with highly applicable.

Wherein, labeling and segmenting and classifying for each object may exact to pixel level. 6D poses will be generated as a transformation matrix 4×4, due to each object already has an initial coordinate when placed in an environment with many other objects, the coordinate will be changed depending on the pose. The 3D point clouds are generated by converting from a stored file (e.g., a CAD file) into point cloud form. Then multiply these point clouds with the 6D pose matrix provided above and from which the 3D point clouds of the objects are generated.

The visibility score of an object helps to make the training more in details and accurate. In particular, herein it will determine which object is upper and which object is lower and based on that it can make a decision whether it should grasp/suction the upper object or not. To calculate the visibility score, it may implement as following. After there has the 3D point cloud as above then proceeding to calculate how many points through which the light ray of the 3D camera passes or visible or reachable, for example by using a known technology (e.g., Ray Tracing). A visible portion and a non-visible portion may be identified using said known technology.

The visible score may be calculated by dividing to obtain a percentage between the visible portion and the non-visible portion or by other suitable methods. For example, the visible score may be calculated by a ratio between a visible score of the 3D point cloud of an object and the total score of the 3D point cloud of said object.

According to a preferred embodiment, the unknown object segmentation model is a combined model using a YOLOv5 network model for detecting objects and a CNN network model having a branch with a mask head for detecting not only bounding boxes but also masks of the objects. Such that, the unknown object segmentation model unit may support to segment all objects inside real images.

After training progress, the unknown object segmentation model processes input images and obtains 2D masks of each individual object in the input image.

Moreover, the unknown object segmentation model also has the ability to detect new objects, and it is fast.

According to one or more implementing embodiments, the unknown object grasping/suctioning model unit outputs target object grasping poses by using a grasping algorithm which applies the known PoinetGPD algorithm according to the above mentioned article, is optimized (optimized PointNetGPD) by adding processing step(s) of points of the 3D point cloud; and outputs target object suctioning poses by applying the known SuctionNet-1Billion algorithm according to the above mentioned article. As for the grasping algorithm uses the optimized PointNetGPD, based on each separated object's pointcloud, extracting interior points near closed region of the grasping hand, using an end-to-end deep learning model to reduce the time to generate grasping poses (grasp poses). As for the suctioning algorithm using the SuctionNet-1Billion algorithm, based on each separated object's point cloud, RGB-D images, providing a large-scale dataset from the real world with messy scenes and noting for a suctioning position, using an end-to-end deep learning model to reduce time and increase accuracy when generating suctioning poses (suction poses).

As already known, the PointNetGPD algorithm is used for creating grasping poses by point clouds. This algorithm selects randomly a point. Then, verifying whether or not the point is possible to be used for creating grasping poses, and generating grasping cases for an one-view point cloud. Its advantage: no training required (use with any point clouds) and applicable to all types of grasping hands. Its disadvantage: the time of execution is not fixed. The known PointNetGPD algorithm is considered impractical to apply in practice due to low speed (especially in some complex contexts, the average time it takes for creating grasping poses may be up to more than a minute, in addition, for easy cases may be also up to 5 s to be completed). This is believed that due to the selecting a point randomly without verifying feasible points or suitable points before applying the algorithm. So that, the present invention is to provide several changes to create an optimized PoinetGPD.

In FIG. 4 illustrating a algorithm flowchart of an optimized PoinetGPD according to a preferred exemplary embodiment for optimizing to generate grasping/suctioning poses.

As shown in FIG. 4, firstly starts at the step 401, calculating normal vectors of visible points of the 3D point cloud of an object; next removing all points with the angle between the normal vector and the vertical axis greater than 45°; finally, applying a farthest point sampling method for points not be removed of the visible points of the 3D point cloud of the object, and simultaneously calculated by appropriate matrix operations. The FPS (Farthest Point Sampling) method is able to be applied due to it has a better coverage. After the optimized PointNetGPD applied, the results were recorded with significantly faster processing speeds. Therefore, it may be used in practical. In addition, there is further grasping poses. This is due to, the original algorithm not only use time for high potential points which is the surface points but also for other points by randomly selected them. Therefore, the original algorithm could not cover entire contexts.

Next, it may perform extraction of interior points near the closed region of the grasping hand: cropping points which are inside the closed region of the grasping hand extracted to provide information through a CNN network.

A deep learning network (for example, an end-to-end deep learning model): a deep learning network based on pointnet++ is used for classifying a cropped point cloud to observe if it is suitable for pick up and vice versa.

Moreover, the SuctionNet-1Billion algorithms is used for creating suctioning poses by point clouds, RGB-D images. In addition, the algorithm also provides a large-scale dataset from the real world with messy scenes and noting suction positions. Due to previous datasets on suctioning be small in scale due to the high demand for expertise and labor-intensive for the labeling people or containing synthesis data may cause real-world performance degradation due to domain differences. Also, there are many algorithms that focus only on single objects, not suitable to deal with messy scenes. The dataset is taken from GraspNet-1Billion, including 88 daily objects with a high-quality 3D mesh model and 190 messy scenes. Each scene includes 512 RGB-D images taken by two different camera, RealSense and Kinect, from 256 view angles. It provides 6D precise suction position of objects, object masks, bounding boxes and camera angles for each view. As for each image, it labels dense suction positions by seal formation scores and resistance scores. In summary, its dataset contains 3, 3 millions to 8, 1 millions suctioning direction for each scene and 1.1 suctioning direction in total. An algorithm uses methods to evaluate a suction pose is good enough based on criteria of the seal score evaluation and wrench score evaluation). Wherein, the seal score evaluation necessary for each individual object, suctioning poses are sampled and annotated using a physical model. Scene annotations are received via projecting objects 6D poses. This process allows for the generation of large-scale datasets suitable well to the real world without heavy manual labor. The wrench score evaluation also very necessary to lift an object, the final actuator of the suction force must be able to resist the moment caused by gravity. There are five specific types of moments to consider: normal force, vacuum force, friction force, torsional friction, elastic restoring moment.

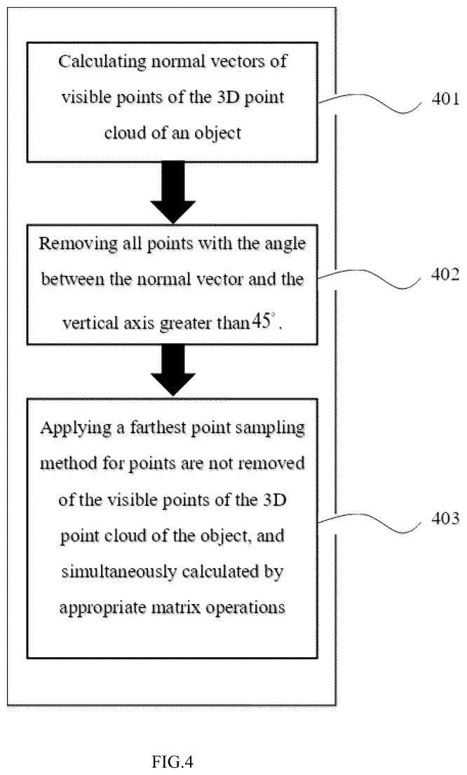

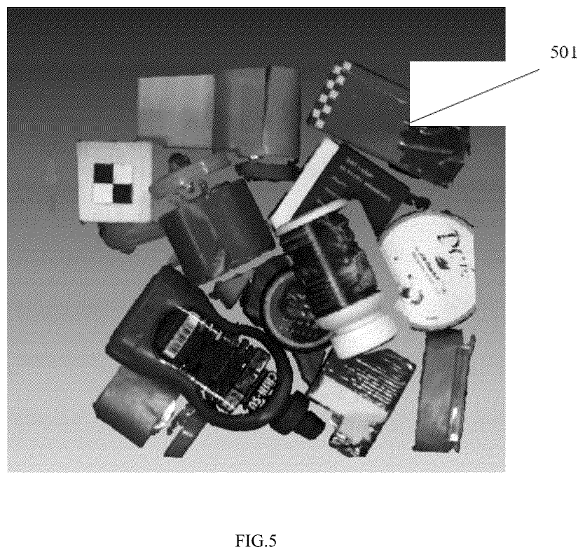

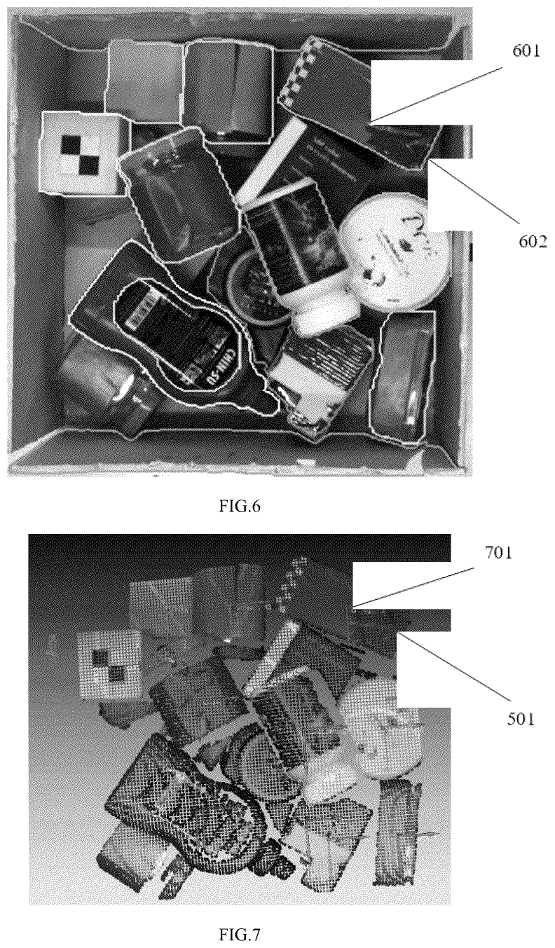

In FIG. 5 and FIG. 6 are screenshots illustrating results related to obtained point clouds, wherein FIG. 5 is a screenshot illustrating point clouds at the surface of objects detected corresponding with the step 201 above and the reference number 501 indicates the point cloud at the surface of an object, and FIG. 6 is a screenshot illustrating segmented objects of several separated objects corresponding with the step 202 above, and reference numbers 601 and 602 indicate an image of a separated object and the segmentation of said object.

According to one or more implementing embodiments, the unknown object segmentation model unit is trained based on a training data set including real data and fake data, wherein the real data are created by 3D camera through actual photography processes and/or taken from available datasets, and the fake data are generated from the real data with a close realism by adding random factors to real images.

In FIG. 7 is a screenshot illustrating normal vectors generated after applying the optimized PointNetGPD algorithm and using the SuctionNet-1Billion algorithm according to an implementing embodiment of the present invention.

Wherein, 501 indicates a separate point cloud image of a separate object and 701 indicates a normal vector which is generated after applying the optimized PointNetGPD algorithm and the SuctionNet-1Billion algorithm.

In FIG. 8 is a perspective view illustrating the system for grasping/suctioning unknown objects according to an implementing embodiment of the present invention.

As shown in FIG. 8, the system for grasping/suctioning unknown objects according to the embodiment using a robot arm 802 with a robot console 805 for grasping/suctioning objects which are products within a product cart 808. A 3D camera 801 is arranged in the upper space corresponding to the product cart for taking the image of the product cart and transfers the image data to a computer 804 to be processed and outputs a control grasping/suctioning decision to the robot arm 802. The robot arm 802 will grasp/suction the products and place them on a conveyor belt 803 ready to convey, for example convey to next unit or section in the manufacturing process, warehousing, or distributing, for example.

Still as shown in FIG. 8, the system for grasping/suctioning unknown objects may further including a cabin using partition panels 807 for forming a workspace area with at least the robot arm 802, the conveyor belt 803, and the product cart 808 therein.

The computer 804 is placed outside of said cabin, for monitoring and performing control tasks for system operations.

The system for grasping/suctioning unknown objects according to the embodiment uses an electrical cabinet 806 to supply power to the system entirely that it is capable to operate independently, a control cabinet 809 to receive signals from outsides for controlling the robot and a tower light 810 to report the status of the entire system (for example, active/stopped/error status).

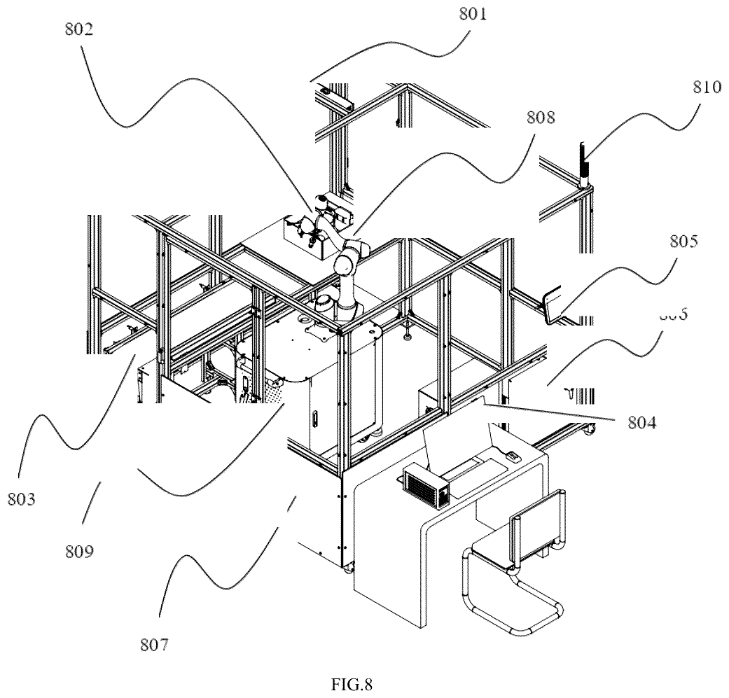

According to a particular example, the 3D camera 801 is a 3D camera Mech-eye Pro M, the robot arm 802 may be equipped with a grasping arm ROBOTIQ 2F-85 (see also in FIG. 9).

Commonly, grasping pose(s) may be calculated for each grasping activity independently, for example in the case only using one gripping unit to perform object gripping, then gripping poses will be calculated suitable to said gripping unit such that it is possible to grasp the target object. In addition, suctioning pose(s) may be calculated for each suctioning activity independently, for example in the case only using one suctioning unit to perform object suctioning, then suctioning poses will be calculated suitable to said suctioning unit such that it is possible to suction the target object.

However, in several cases, for example for objects not predetermined in shape, or having different various shapes, to take these objects out of the product cart, using only one gripping unit or using only one suctioning unit may not be effective, such as grasping/suctioning pose does not generate enough force and/or position for gripping/suctioning an object reliably, may reduce the success rate in taking the object out of the product cart.

To solve this problem, an aspect according to the present invention provides that the grasping/suctioning will use one or more gripping units, one or more suctioning units, or combine between one or more gripping units and one or more suctioning units. Such as, one gripping unit is combined with one suctioning unit to perform for taking an object, one gripping unit is combined with two or more than two suctioning units to perform for taking an object, two suctioning units are combined with each other to perform for taking an object, or three or more than three suctioning units are combined with each other to perform for taking an object, for example.

In FIG. 9 is a perspective view illustrating a grasping/suctioning hand assembly according to an implementing embodiment of the present invention.

As shown in FIG. 9, the grasping/suctioning hand assembly includes a suction cup 901, a flange 902, a stroke cylinder 903, cylinder mounts 904 and 906, suctioning unit mount 905, and grasping hand 907.

More in particular, the grasping hand 907 may be a grasping hand ROBOTIQ 2F-85 is equipped on a robot Doosan. The suctioning unit may comprise: the suction cup 901 and the stroke cylinder 903 which changes the height of the suction cup 901. When in initial state the stroke cylinder 903 in retracting state and the suction cup 901 in resting state, when the robot moves to the suction position the stroke cylinder 903 move downward and the suction cup 901 in active state for suctioning an object, after taking the object to the conveyor belt, the suction cup 901 will back to resting state to place the object onto the conveyor belt and the stroke cylinder 903 retracts.

In addition, as preferably, the 3D panoramic images taken during operation of the system are processed and added to the training data set as additional real data for use in various purposes, for example monitoring, conducting additional training, or retraining the model. But not be limited thereto.

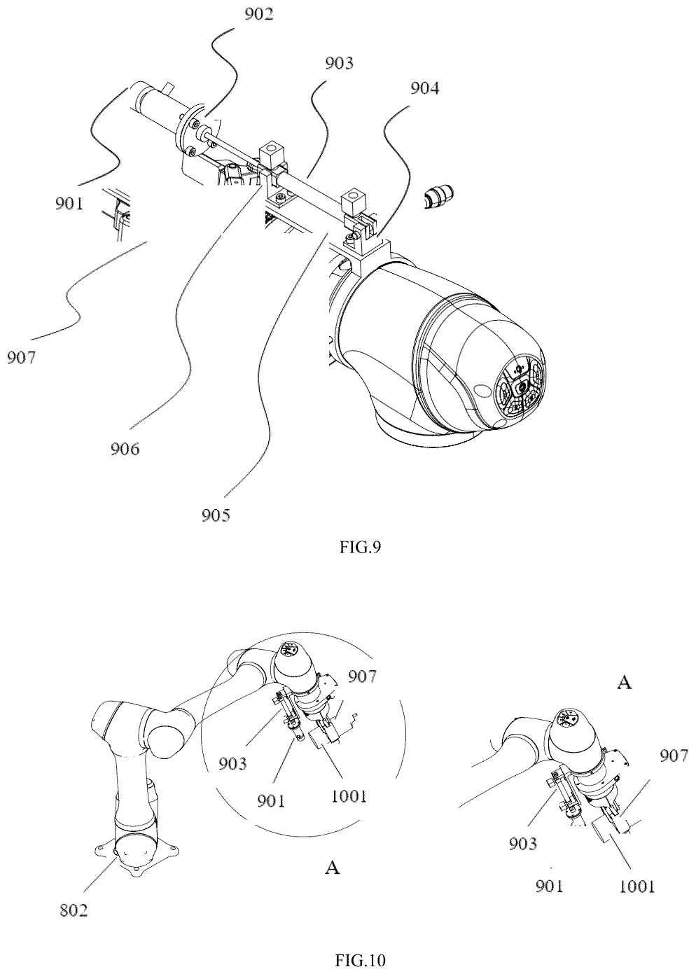

In FIG. 10 is a perspective view illustrating a grasping pose of the robot arm with the portion A is enlarged.

As shown in FIG. 10, the robot arm 802 is performing a grasping operation according to the algorithm described above. The robot arm 802 is equipped with the suction cup 901, the stroke cylinder 903, the grasping hand 907. The grasping hand 907 is being shown as grasping the target object 1001 independently while the suction cup 901 is not active.

Herein, may suppose that the system for grasping/suctioning unknown objects according to the present invention performs the processing for outputting the feasible grasping/suctioning pose, and determines that the feasible grasping/suctioning pose is only using the grasping hand 907 independently to grasp the target object. Accordingly, the robot arm 802 is controlled to generate a grasping pose related to the target object 1001, the grasping hand 907 is activated and close to grasp the target object 1001 and there is no collision between the target object 1001 and the grasping hand 907 as well as mentioned components with other outside components.

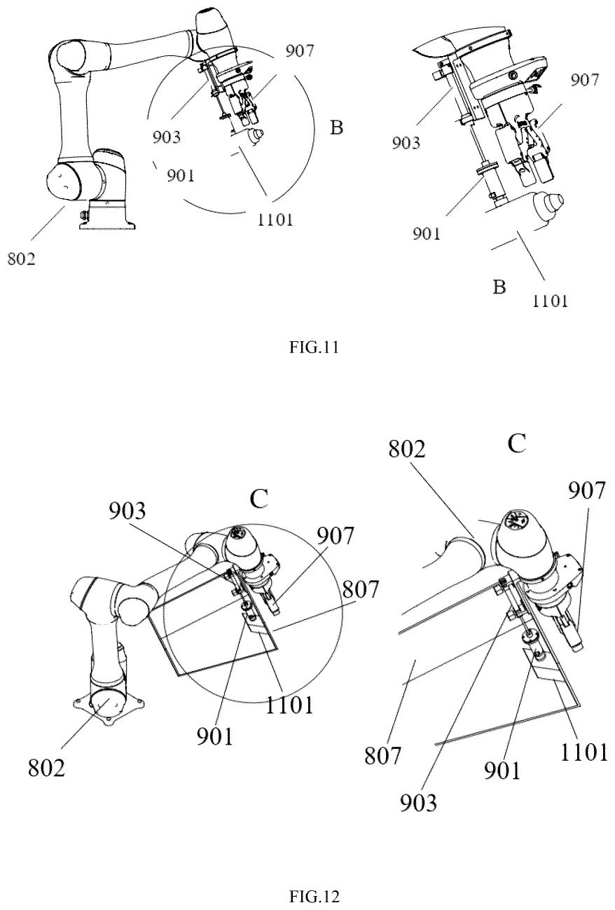

In FIG. 11 is a perspective view illustrating a suctioning pose of the robot arm with the portion B is enlarged.

As shown in FIG. 11, the robot arm 802 is performing a suctioning operation according to the algorithm described above. The robot arm 802 includes the suction cup 901, the stroke cylinder 903, the grasping hand 907 and the target object 1101. The suction cup 901 is being shown as suctioning the target object 1001 independently while the grasping hand 907 is not active.

Herein, may suppose that the system for grasping/suctioning unknown objects according to the present invention performs the processing for outputting the feasible grasping/suctioning pose, and determines that the feasible grasping/suctioning pose is that using the suction cup 901 independently to suction the target object. Accordingly, the robot arm 802 is controlled to generate the suctioning pose of the target object 1101, the stroke cylinder 903 moves downward and the suction cup 901 is activated to suction the target object 1101 and there is no collision between the target object 1201 and the suction cup 901 and the stroke cylinder 903 as well as mentioned components with other outside components.

FIG. 12 is a perspective view illustrating more clearly a particular suctioning pose of the robot arm performing to suction an object which is a product contained in a product cart.

As shown in FIG. 12, the suctioning pose of the robot arm 802 is generated to prevent collisions between the suction cup 901, the product cart 807, the grasping hand 907 and the target object 1101.

In particular, the robot arm 802 is equipped with the suction cup 901, the stroke cylinder 903, the grasping hand 907, being to suction the target object 1101 located close to a wall of the product cart 807. Herein, may suppose that the system for grasping/suctioning unknown objects according to the present invention performs the processing for outputting the feasible grasping/suctioning pose and determines that the feasible grasping/suctioning pose is that using the suction cup 901 instead of using the grasping hand 907 due to using the grasping hand 907 may make a collision between the robot arm 802 and the wall of the product cart 807. Accordingly, the robot 802 generates the suctioning pose to suction the target object 1101, the stroke cylinder 903 moves downward and the suction cup 901 is activated to suction the target object 1101 and there is no collision between the objects and suction cup 901, the stroke cylinder 903, and the product cart 807 with each other.

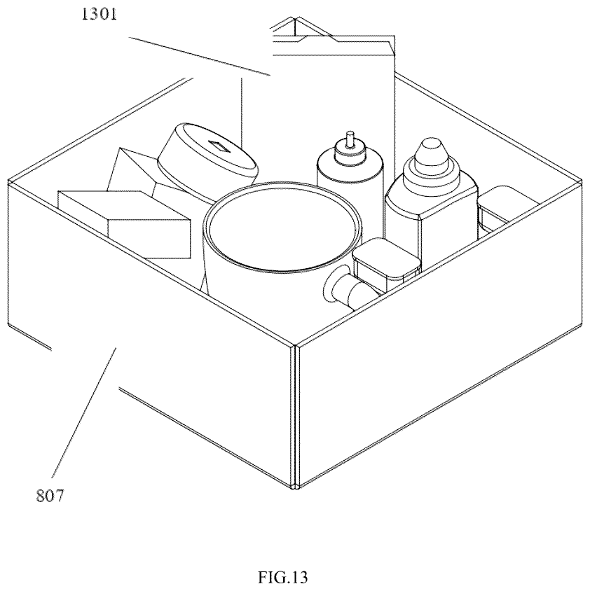

In FIG. 13 is a perspective view illustrating the product cart according to an exemplary embodiment of the present invention.

As shown in FIG. 13, the product cart 807 contains products 1301 in said product cart 807, wherein the products 1301 are objects with any shapes and are considered as unknown objects.

The product cart 807 with the inside portion of the product cart is the image taking of the camera 801 and the captured region including the objects in the product cart 807 or the products 1301 themselves.

According to one or more preferred embodiments of the present invention, the robot arm includes at least one suctioning unit defined as the center suctioning unit, the gripping unit including grippers, and the center suctioning unit is in the center of grippers of the gripping unit, such that when the gripping unit performs for gripping the target object grippers of the gripping unit contact gripping points on a surface of the target object, the suctioning unit is in the center of said grippers is capable of contacting a suctioning point on surfaces of the target object in the center of said gripping points.

Preferably, the robot arm has an arm terminal segment is defined as the farthest arm segment from a fixed structure that supports the robot arm, for mounting the gripping unit and the suctioning units thereon, suctioning units other than the center suctioning unit, are defined as the surrounding suctioning units.

The gripping unit includes the grasping hand with at least two gripping fingers, the center suctioning unit is in between said at least two gripping fingers.

Each of the surrounding suctioning units including the stroke cylinder and the suction cup is mounted at one end of the stroke cylinder, such that the suction cup capable of pushing out and retracting. The stroke cylinders are fixed surrounding the arm terminal segment, and there have axes of the stroke cylinders parallel to each other and parallel to an axis of the arm terminal segment. Optionally, the number of the surrounding suctioning units are two, three, or more than three.

Preferably, when defining an imaginary circle which is a circle perpendicular to the axis of the arm terminal segment and with its center is on the axis of the arm terminal segment, then the surrounding suctioning units are located within the range of substantially a half of said imaginary circle. This is for the purpose to reduce collision possibilities, the reason is that although there is a plurality of surrounding suctioning units may be used, however another half of said imaginary circle does not have any surrounding suctioning unit be arranged, thus not causing collision or obstruction which relates to said another half of the imaginary circle.

According to one or more preferred embodiments, the system according to the present invention may further include an object classification model unit for classifying objects contained in the containing space, based on at least surfaces and shapes of the objects, and based on the classification result of an object to determine manners to obtain said object out of the containing space, wherein the manner to obtain the object is defined as gripping, or suctioning, or gripping and suctioning at the same time using the robot arm.

A person skilled in the art may understand that objects contained in the containing space may be classified by many different methods according to practical applications and/or may be classified into certain groups. In addition, objects contained in the containing space may be classified in large groups, and after that in each large group, it may be classified in smaller groups, but not be limited thereto. In addition, during implementation it may be changed, adjusting, or adding classifications, for example adding more groups.

According to a particular example, objects contained in the containing space may be classified into different groups, including but not limited to, taking out by using the gripping unit, taking out by using the gripping unit combined with the suctioning unit, taking out by using more than one suctioning unit, for example.

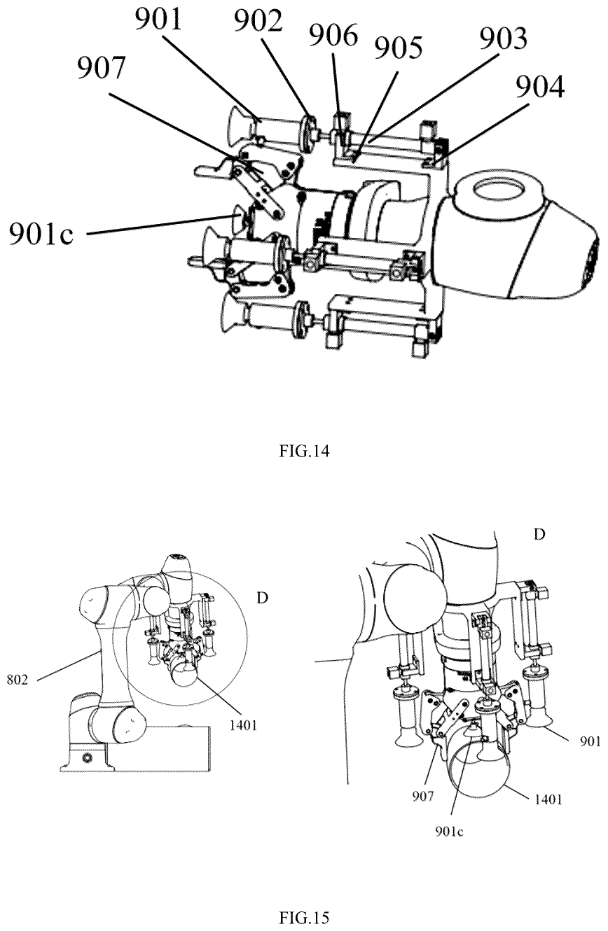

To illustrate further the object grasping/suctioning which uses gripping unit(s) and/or suctioning unit(s), some implementing embodiments relates to grasping/suctioning poses, wherein not only using one gripping unit, one suctioning unit, but also using a combination of one or more than one gripping unit and one or more than one suctioning unit will be described with reference to figures from FIG. 14 to FIG. 19.

In FIG. 14 is a perspective view illustrating grasping/suctioning hand assembly including a gripping unit and plurality of suctioning units according to an exemplary embodiment of the present invention.

As shown in FIG. 14, the grasping/suctioning hand assembly according to the exemplary embodiment includes a gripping unit, a center suctioning unit, three surrounding suctioning units are located within the range of substantially a half of an imaginary circle as described above. The gripping unit includes a grasping hand 907. The center suctioning unit includes a center suction cup 901c mounted at one end of the stroke cylinder (not shown clearly in the drawing). Each of surrounding suctioning units including surrounding suction cups 901, a flange 902, a stroke cylinder 903, cylinder mounts 904 and 906, and suctioning unit mounts 905. The suctioning unit mounts 905 may be provides as parts of a single unit structure mounted on the robot arm as shown in the figure, but the present invention is not limited thereto.

It is easy to recognize that, with the structure illustrated in FIG. 14, the grasping hand 907 may operate independently for taking out the target object, or may be combined with the center suction cup 901c for taking out the target object. The surrounding suction cups 901 may operate independently for taking out the target object, or may be combined with each other for taking out the target object. In addition, the grasping hand 907 may be combined with one or more surrounding suction cups 901, the center suction cup 901c may operate independently or combined with one or more surrounding suction cups 901 in any ways.

Preferably, when there are more than one grasping/suctioning component be used, one grasping/suctioning component be selected as reference component for calculating a feasible grasping/suctioning pose, and after that remain grasping/suctioning components will be calculated based on the pose/position of said reference grasping pose which has been calculated. For example, in the case that the grasping hand 907 is used in combination with the center suction cup 901c for taking out the target object, then the grasping hand 907 may be selected as a reference component to calculate a feasible grasping/suctioning pose suitable to apply for the grasping hand 907, after that a suctioning pose of the center suction cup 901c will be calculated according to said feasible grasping/suctioning pose which is applied for the grasping hand 907. However, the present invention is not limited thereto.

In FIG. 15 is a perspective view illustrating grasping combined with suctioning poses of a robot arm with the portion D is enlarged.

As shown in FIG. 15, the robot arm 802 is performing to grasp/suction the target object 1401. The target object 1401 is gripped by the grasping hand 907, as well as suctioned by the center suction cup 901c. The surrounding suction cups 901 are in the non-active state.

Herein, may suppose that the system for grasping/suctioning unknown objects according to the present invention performs the processing for outputting the feasible grasping/suctioning pose, and determines that the feasible grasping/suctioning pose is that using a combination of the grasping hand 907 and the center suction cup 901c for simultaneously grasping and suctioning the target object. Accordingly, the robot arm 802 is controlled to generate a grasping pose as well as a suctioning pose for the target object 1401. To perform simultaneously grasping and suctioning, firstly a grasping pose corresponding to the grasping hand 907 may be given, then a suctioning pose corresponding to the center suction cup 901c will be calculated based on the given grasping pose of the grasping hand 907. However, the present invention is not limited thereto, a grasping/suctioning pose may be simultaneously calculated for both the grasping hand 907 and the center suction cup 901c may be applied.

In reality, due to the center suction cup 901c is arranged in the center of the grasping hand 907, it may be easy and convenient to generate a suctioning pose corresponding with the center suction cup 901c based on the given grasping pose of the grasping hand 907.

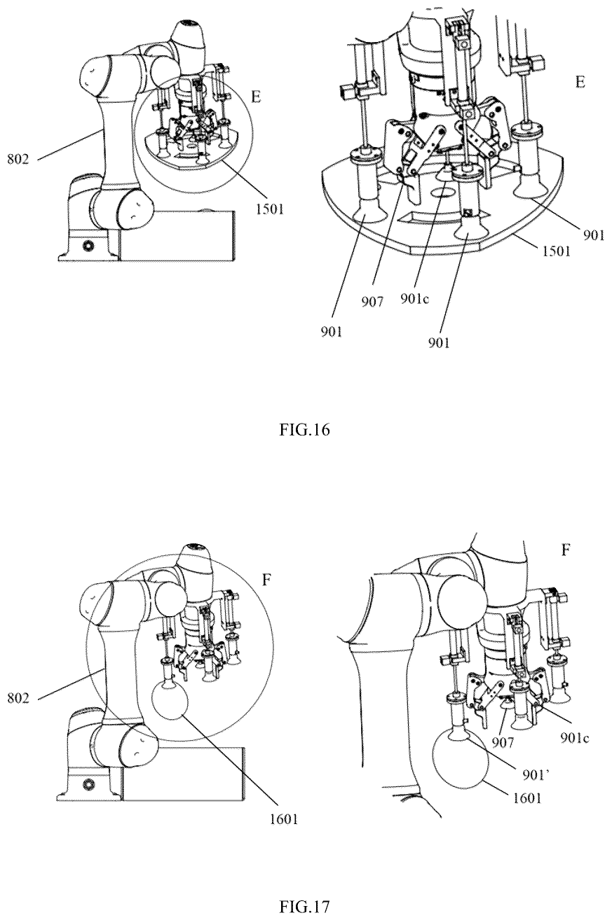

In FIG. 16 is a perspective view illustrating a suctioning pose combined more than one suctioning unit of the robot arm with the portion E is enlarged.

As shown in FIG. 16, the robot arm 802 is performing to suction the target object 1501. The target object 1501 is suctioned by three surrounding suction cups 901. The grasping hand 907 and the center suction cup 901c are in the non-active state.

Herein, may suppose that the system for grasping/suctioning unknown objects according to the present invention performs the processing for outputting the feasible grasping/suctioning pose, and determines that the feasible grasping/suctioning pose is that using three surrounding suction cups 901 to suction the target object. Accordingly, the robot arm 802 is controlled to generate a suctioning pose using three surrounding suction cups 901 at the same time to suction the target object 1501. To perform, firstly a suctioning pose corresponding with one specific surrounding suction cup 901 will be given, then suctioning poses corresponding with the remain surrounding suction cups 901 will be calculated based on the given suctioning pose. However, the present invention is not limited thereto, suctioning poses may be simultaneously calculated for all three surrounding suction cups 901 may be applied.

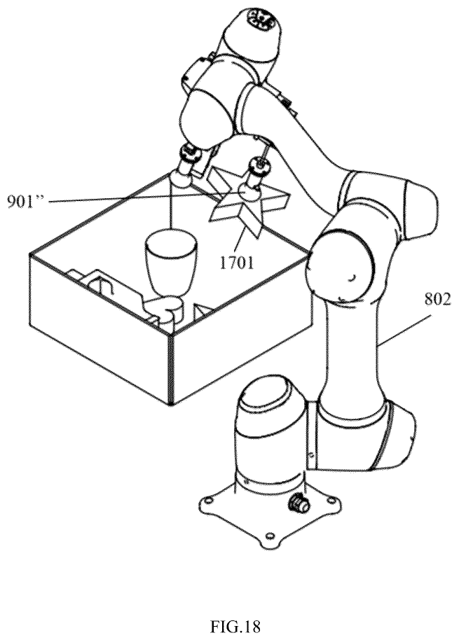

In the figures from FIG. 17 to FIG. 19 are perspective view illustrating suctioning poses using different the surrounding suction cups.

As shown in FIG. 17, the robot arm 802 is performing to suction the target object 1601. The target object 1601 is suctioned by the surrounding suction cup 901′. The remain surrounding suction cups other than the surrounding suction cup 901′, the grasping hand 907, and the center suction cup 901c are in the non-active state.

Herein, may suppose that the system for grasping/suctioning unknown objects according to the present invention performs the processing for outputting the feasible grasping/suctioning pose, and determines that the feasible grasping/suctioning pose is that using the surrounding suction cup 901′ to suction the target object will not cause a collision with the wall of the product cart, whereas if it uses the remain surrounding suction cups may cause a collision with the wall of the product cart. In addition, may also suppose that the position of the surrounding suction cup 901′ is closest and convenient for the joints of the robot arm move to the suctioning position, and therefore the surrounding suction cup 901′ is used.

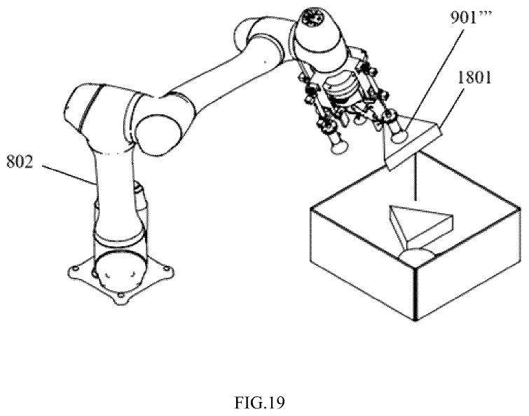

As shown in FIG. 18, the robot arm 802 is performing to suction the target object 1701. The target object 1701 is suctioned by the suction cup 901″ other than the surrounding suction cup 901′ used in FIG. 17. The remain surrounding suction cups other than the surrounding suction cup 901″, the grasping hand 907, and the center suction cup 901c are in the non-active state.

Herein, may suppose that the system for grasping/suctioning unknown objects according to the present invention performs the processing for outputting the feasible grasping/suctioning pose, and determines that the feasible grasping/suctioning pose is that using the surrounding suction cup 901″ to suction the target object will not cause a collision with the wall of the product cart, whereas if it uses the remain surrounding suction cups may cause a collision with the wall of the product cart. In addition, may also suppose that the position of the surrounding suction cup 901″ is closest and convenient for the joints of the robot arm move to the suctioning position, and therefore the surrounding suction cup 901″ is used.

As shown in FIG. 19, robot arm 802 is performing to suction the target object 1801. The target object 1801 is suctioned by the suction cup 901′″ other than the surrounding suction cup 901′ used in FIG. 17 and the surrounding suction cup 901″ used in FIG. 18. The remain surrounding suction cups other than the surrounding suction cup 901′″, the grasping hand 907, and the center suction cup 901c are in the non-active state.

Herein, may suppose that the system for grasping/suctioning unknown objects according to the present invention performs the processing for outputting the feasible grasping/suctioning pose, and determines that the feasible grasping/suctioning pose is that using the surrounding suction cup 901′″ to suction the target object will not cause a collision with the wall of the product cart, whereas if it uses the remain surrounding suction cups may cause a collision with the wall of the product cart. In addition, may also suppose that the position of the surrounding suction cup 901′″ is closest and convenient for the joints of the robot arm move to the suctioning position, and therefore the surrounding suction cup 901′″ is used.

Although some embodiments have been described herein and may accompanying with alternative or equivalent embodiments or specific exemplarily embodiment, using suitable descriptive terms and technical terms for person skilled in the art may understand and pertain the present invention. Therefore, the person skilled in the art may obviously implement modifications, equivalent arrangements, or variations based on the described embodiments. Therefore, all these modifications, equivalents, or variations fall within the protection scope of the claims appended, and the scope of the protection of the present invention is obviously not limited to contents and descripted embodiments but is defined in the following claims.

What is claimed is:

1. A system for grasping/suctioning unknown objects comprising:
at least one robot arm including at least one gripping unit and one or more suctioning units adeptly provided for grasping/suctioning a target object among objects contained in a containing space;
at least one 3D camera for taking images of the objects contained in said containing space and creating a 3D panoramic image;
an unknown object segmentation model unit for receiving said 3D panoramic image as an input, and processing the 3D panoramic image for creating a 2D mask and a 3D point cloud of each individual object in the 3D panoramic image;
an unknown object grasping/suctioning model unit for outputting grasping/suctioning poses related to the target object attached to at least one portion of visible points of the 3D point cloud of the target object respectively, and selecting a feasible grasping/suctioning pose for controlling the robot arm to grasp/suction the target object according to said feasible grasping/suctioning pose;
wherein:
the target object is one object among the objects contained in the containing space is selected based on its visible score, wherein a visible score of any object among the objects contained in the containing space is calculated by a ratio between a visible score of the 3D point cloud of the object and a total score of the 3D point cloud of the object;
the feasible grasping/suctioning pose is a grasping/suctioning pose among the grasping/suctioning poses related to the target object is selected based on a collision calculation, wherein said collision is a collision between the robot arm and the objects contained in the containing space in the vicinity of the target object, and/or objects which make a limitation to the containing space or present in the containing space.

2. The system according to claim 1, wherein the target object is gripped by at least one gripping unit independently, suctioned by one or more suctioning units independently, or simultaneously gripped by at least one gripping unit and suctioned by one or more suctioning units.

3. The system according to claim 2, wherein the robot arm including at least one suctioning unit is defined as a center suctioning unit, the gripping unit including grippers, and the center suctioning unit is in the center of the grippers of the gripping unit, such that when the gripping unit performs for gripping the target object, the grippers of the gripping unit contact gripping points on a surface of the target object, the suctioning unit is in the center of said grippers is capable of contacting a suctioning point on the surface of the target object which is in the center of said gripping points.

4. The system according to claim 3, wherein the robot arm having an arm terminal segment, is defined as the farthest arm segment from a fixed structure that supports the robot arm, for mounting the gripping unit and the suctioning units thereon, suctioning units other than the center suctioning unit, are defined as the surrounding suctioning units,
wherein:
the gripping unit including a grasping hand with at least two gripping fingers, the center suctioning unit is in the center of said at least two gripping fingers,
each of the surrounding suctioning units including a stroke cylinder and a suction cup is mounted at one end of the stroke cylinder, such that the suction cup capable of pushing out and retracting,
wherein the stroke cylinders are fixed surrounding the arm terminal segment, and there have axes of the stroke cylinders parallel to each other and parallel to an axis of the arm terminal segment.

5. The system according to claim 4, wherein the number of the surrounding suctioning units are two, three, or more than three.

6. The system according to claim 5, wherein when defining an imaginary circle which is a circle perpendicular to the axis of the arm terminal segment and with its center is on the axis of the arm terminal segment, then the surrounding suctioning units are located within the range of substantially a half of said imaginary circle.

7. The system according to claim 6, wherein the system further comprising an object classification model unit for classifying objects contained in the containing space, based on at least surfaces and shapes of the objects, and based on classification result of an object to determine manners to obtain said object out of the containing space, wherein the manner to obtain the object is defined as gripping, or suctioning, or gripping and suctioning at the same time using the robot arm.

8. The system according to claim 1, wherein the system is configured to:
determining normal vectors at the visible points of said 3D point cloud corresponding to the surface of the target object,
calculating angles between the normal vectors with the vertical axis of the coordinate according to the 2D image,
removing points with calculated angles greater than 45°, and
outputting grasping/suctioning poses related to the target object attached to at least one portion of visible points of the 3D point cloud which are not removed.

9. The system according to claim 8, wherein the grasping/suctioning poses related to the target object are simultaneously calculated by appropriate matrix operations.

10. The system according to claim 1, wherein the unknown object segmentation model unit is trained based on a training data set including real data and fake data, wherein the real data are created by 3D camera through actual photography processes and/or taken from available datasets, and the fake data are generated from the real data with a close realism by adding random factors to real images.

11. The system according to claim 10, wherein the unknown object segmentation model is a combined model using a YOLOv5 network model for detecting objects and a CNN network model having a branch with a mask head for detecting not only bounding boxes but also masks of the objects.

12. The system according to claim 1, wherein the containing space is a product cart, and the objects contained in the containing space are products contained in said product cart.

13. The system according to claim 12, wherein the system further comprising conveyor belts, products contained in product carts being grasping/suctioning out by the robot arm shall be placed on the conveyor belts ready for transferring.

14. The system according to claim 13, wherein the system further comprising a cabin using partition panels for forming a workspace area with at least the robot arm, the conveyor belts, and the product carts in said workspace area.

15. The system according to claim 14, wherein the system further comprising a computer is placed outside of said cabin, for monitoring and performing control tasks for system operations.

16. The system according to claim 15, wherein the 3D panoramic images taken during operation of the system are processed and added to a training data set as additional real data.
